(19) United States
(12) Patent Application Publication
(10) Pub. No.: US 2001/0000342 A1
(43) Pub. Date: Apr. 19, 2001

(54) Hydrocarbon/acrylic hybrid resins for use in lithographic printing ink formulations

(75) Inventor: Michael D. Matzinger, Charlotte, NC (US)

Correspondence Address: Daniel B. Reece IV, Westvaco Corporation, 5255 Virginia Avenue, Post Office Box 118005, Charleston, SC, 29423-8005, US

(73) Assignee: Westvaco Corporation, New York, NY (US)

(21) Appl. No.: 09/726,187

(22) Filed: Nov. 29, 2000

Related U.S. Application Data
(63) Continuation-in-part of application No. 09/315,625, filed on May 20, 1999.

(51) Int. Cl. C08L 55/00; C09D 11/10

(52) U.S. Cl. 523/160; 524/554

(57) ABSTRACT

The present invention relates to lithographic printing ink systems containing improved binder resins. In particular, the invention relates to the use of hydrocarbon/acrylic hybrid resin binder compositions in lithographic printing ink formulations.

1. This application is a continuation-in-part of my commonly assigned, co-pending U.S. patent application, Ser. No. 09/315,625 filed May 20, 1999, entitled “Hydrocarbon/Acrylic Hybrid Resins For Use In Lithographic Printing Ink Formulations”.

### FIELD OF INVENTION

2. The present invention relates to lithographic printing ink systems containing improved binder resins. In particular, the invention relates to the use of hydrocarbon/acrylic hybrid resin binder compositions in lithographic printing ink formulations.

### BACKGROUND OF THE INVENTION

3. Lithographic printing inks consist primarily of pigments, natural and/or synthetic resins with high melting points (100 to 200° C.), alkyd resins, and hydrocarbon resins. Low concentrations of plasticizers, antioxidants, chelates, pH modifiers, antiskinning agents, and other additives also are included in lithographic ink formulations.

4. The natural and synthetic high-melting resins are typically either petroleum-derived or wood-derived. Used solely or in combination, these resins are dissolved in high-boiling hydrocarbon solvents to give homogeneous systems well known in the art as varnishes. Varnishes usually contain 20 to 70% resin solids. The alkyds, plasticizers, and antioxidants are often included in the varnish, so that solids levels may exceed 70%.

5. Resins must meet several general requirements to be useful as lithographic ink resins. In order to make varnishes, for example, they must be capable of being dissolved in high-boiling hydrocarbon solvents to yield clear varnishes with manageable viscosities for easy workability. The varnishes must be stable in storage to viscosity, color, and clarity changes. On paper, the resin in the varnish or finished ink must dry to yield a durable, smooth, and uniform film with good resistance to abrasion and chemicals.

6. Moreover, it is appreciated that for resin to be useful as dispersing resins in lithographic ink pigment processing operations such as flushing, the resins must exhibit several specific properties in addition to the aforementioned requirements general to all lithographic ink resins. For example, when mixed with highly aqueous pigment presscake in high torque dough mixers commonly used for flushing operations, the resins present in the lithographic ink varnish must exhibit excellent pigment wetting properties. Such properties lead to rapid and thorough coverage of pigment particles present in the presscake and to the concurrent displacement of water originally bound to or entrained in the particle aggregates and agglomerates. Good wetting properties also lead to strong adhesion of resin to particle surfaces so that, as aggregates and agglomerates are broken down into primary particle units, resin will coat the particle surfaces thereby providing a steric barrier to particle-particle reaggregation and reagglomeration. Strong adhesion to and through coverage of surfaces of primary particle units by resin thus leads to increased color strength, gloss, and transparency, as well as reducing bronzing in the resulting pigment concentrate.

7. Strong pigment-wetting characteristics are exhibited by compounds which have structures consisting of polar head groups attached to oleophilic tail segments. The polar head groups bind to the polar pigment particle surfaces while the oleophilic tail segments solubilize the bound particle with the continuous medium and also provide a steric barrier to particle-particle interactions.

8. Heretofore it was difficult with hydrocarbon resins to impart this type of structure which enables strong pigment wetting characteristics. The usual methods for preparing hydrocarbon resins yield nonpolar molecules which do not meet the necessary structural requirements on the molecular level for enhanced pigment wetting. The only polar units present in hydrocarbon resins produced via such common synthetic methods are the hydroxyl and carboxyl functionalities; and these are typically sterically hindered due to their participation in esterification or insertion reactions; hence they are unavailable often for interaction with polar pigment particle surfaces.

9. Accordingly, an object of the present invention to provide a hydrocarbon/acrylic hybrid resin binder composition suitable for use in formulating improved lithographic printing inks.

10. A further object of the present invention is to provide a hydrocarbon/acrylic hybrid resin binder composition having viscosity and solubility properties which enable its incorporation into lithographic printing ink formulations.

11. Other objects, features, and advantages of the invention will be apparent from the details of the invention as more fully described and claimed.

### SUMMARY OF THE INVENTION

12. The objects of this invention are achieved by reacting carboxylic acid functionalized acrylic polymers with dicyclopentadiene and other hydrocarbon monomers to produce the desired hydrocarbon/acrylic hybrid resin binder compositions suitable for use in lithographic printing ink formulations. Alternatively, the objects of this invention are also achieved by reacting carboxylic acid functionalized acrylic polymers with dicyclopentadiene and hydrocarbon resins and/or modified hydrocarbon resins to produce the desired hydrocarbon/acrylic hybrid resin binder compositions suitable for use in lithographic printing ink formulations. Such lithographic printing ink formulations have been found to exhibit improved color strength, gloss, and transparency characteristics, as well as reduced bronzing in the resulting pigment concentrates.

### DESCRIPTION OF THE PREFERRED EMBODIMENT

13. The hydrocarbon/acrylic hybrid resin binder composition for use in lithographic ink formulations which is an object of the present invention comprises the graft copolymer reaction product produced by reacting:

14. a) about 2% to about 63% by total weight of the reactants of dicyclopentadiene;

15. b) about 2% to about 63% by total weight of the reactants of a member selected from the group consisting of hydrocarbon monomers capable of undergoing polymerization with dicyclopentadiene and combinations thereof;

16. c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

17. d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

18. at a temperature of from about 160°C. to about 300° C. for a time sufficient to produce the lithographic ink binder composition.

19. A preferred hydrocarbon/acrylic hybrid resin binder composition for use in lithographic ink formulations comprises the graft copolymer reaction product produced by reacting:

20. a) about 10% to about 40% by total weight of the reactants of dicyclopentadiene;

21. b) about 10% to about 40% by total weight of the reactants of a member selected from the group consisting of hydrocarbon monomers capable of undergoing polymerization with dicyclopentadiene and combinations thereof;

22. c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

23. d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

24. at a temperature of from about 220° C. to about 280° C. for a time sufficient to produce the lithographic ink binder composition.

25. Another hydrocarbon/acrylic hybrid resin binder composition for use in lithographic ink formulations comprises the graft copolymer reaction product produced by:

26. 1) reacting

27. a) about 2% to about 63% by total weight of the reactants of dicyclopentadiene;

28. b) about 2% to about 63% by total weight of the reactants of a member selected from the group consisting of hydrocarbon monomers capable of undergoing polymerization with dicyclopentadiene and combinations thereof; and

29. c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

30. at a temperature of from about 160° C. to about 300° C. for a time sufficient to produce a resin composition; and

31. 2) further reacting:

32. a) about 35% to about 98% by total weight of the reactants of said resin composition, and

33. b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, β,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

34. at a temperature of from about 160° C. to about 300° C. for a time sufficient to produce the lithographic ink binder composition.

35. A preferred hydrocarbon/acrylic hybrid resin binder composition for use in lithographic ink formulations comprises the graft copolymer reaction product produced by:

36. 1) reacting

37. a) about 10% to about 40% by total weight of the reactants of dicyclopentadiene;

38. b) about 10% to about 40% by total weight of the reactants of a member selected from the group consisting of hydrocarbon monomers capable of undergoing polymerization with dicyclopentadiene and combinations thereof; and

39. c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

40. at a temperature of from about 220° C. to about 280°C. for a time sufficient to produce a resin composition, and

41. 2) further reacting

42. b) about 50% to about 80% by total weight of the reactants of said resin composition, and

43. b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

44. at a temperature of from about 220° C. to about 280°C. for a time sufficient to produce the lithographic ink binder composition.

45. A further hydrocarbon/acrylic hybrid resin binder composition for use in lithographic ink formulations comprises the graft copolymer reaction product produced by reacting:

46. a) about 2% to about 63% by total weight of the reactants of dicyclopentadiene;

47. b) about 2% to about 63% by total weight of the reactants of a member selected from the group consisting of hydrocarbon resins, modified hydrocarbon resins, and combinations thereof;

48. c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

49. d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

50. at a temperature of from about 140°C. to about 300°C. for a time sufficient to produce the lithographic ink binder composition.

51. A preferred hydrocarbon/acrylic hybrid resin binder composition for use in lithographic ink formulations comprises the graft copolymer reaction product produced by reacting:

52. a) about 10% to about 40% by total weight of the reactants of dicyclopentadiene;

53. b) about 10% to about 40% by total weight of the reactants of a member selected from the group consisting of hydrocarbon resins, modified hydrocarbon resins, and combinations thereof;

54. c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

55. d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α, β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

56. at a temperature of from about 180°C. to about 260°C. for a time sufficient to produce the lithographic ink binder composition.

57. A further improved hydrocarbon/acrylic hybrid resin binder composition for use in lithographic ink formulations comprises the graft copolymer reaction product produced by:

58. 1) reacting

59. a) about 2% to about 63% by total weight of the reactants of dicyclopentadiene;

60. b) about 2% to about 63% by total weight of the reactants of a member selected from the group consisting of hydrocarbon resins, modified hydrocarbon resins, and combinations thereof; and

61. c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

62. at a temperature of from about 140°C. to about 300°C. for a time sufficient to produce a resin composition; and

63. 2) further reacting:

64. a) about 35% to about 98% by total weight of the reactants of said resin composition, and

65. b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

66. at a temperature of from about 140°C. to about 300°C. for a time sufficient to produce the lithographic ink binder composition.

67. A preferred hydrocarbon/acrylic hybrid resin binder composition for use in lithographic ink formulations comprises the graft copolymer reaction product produced by:

68. 1) reacting

69. a) about 10% to about 40% by total weight of the reactants of dicyclopentadiene;

70. b) about 10% to about 40% by total weight of the reactants of a member selected from the group consisting of hydrocarbon resins, modified hydrocarbon resins, and combinations thereof, and

71. c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

72. at a temperature of from about 180°C. to about 260°C. for a time sufficient to produce a resin composition, and

73. 2) further reacting

74. a) about 50% to about 80% by total weight of the reactants of said resin composition, and

75. b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

76. at a temperature of from about 180° C. to about 260° C. for a time sufficient to produce the lithographic ink binder composition.

77. Depending upon the characteristics desired, the hydrocarbon/acrylic hybrid resin lithographic ink binder compositions of the present invention can be formed via two differing methods. In one method, hydrocarbon/acrylic resins are formed by heating a mixture of hydrocarbon monomers (wherein one of the monomers is dicyclopentadiene), one or more acrylic resins and, optionally, specified additional chemical compounds to temperatures of from about 160° C. to about 300°C. (preferably from about 220° C. to about 280°C.). The weight ratio of acrylic polymer to hydrocarbon monomers usually is about 2:1 to 1:45. The components are charged to a reactor which is then sealed and heated to a temperature within the desired range. The procedure generally is performed under an inert atmosphere by purging the charged reactor with nitrogen prior to sealing it. As the mixture is heated, an autogenous pressure of between 70 and 160 psig is usually generated. After maximizing, this pressure generally falls to between 40 and 70 psig as the polymerization proceeds. The reaction mixture is maintained at a temperature within the desired range under pressure for a period sufficient to achieve a hydrocarbon/acrylic hybrid resin possessing the desired properties. Typically a time of at least three hours is employed. Following this, the reactor is vented to reduce the pressure to 0 psig. Next, unreacted hydrocarbon monomers and inert compounds that would depress the softening point of the resin and give it an offensive odor are distilled from the reaction mixture. The removal of these materials is promoted by sparging the resin with nitrogen. Nitrogen is bubbled through the reaction mixture generally at a rate of 0.001 to 0.01 lb of N₂ per lb of reactants per hour. The length of this step is dependent on the desired properties of the resin but typically is conducted from one to ten hours.

78. Alternatively, in the second method hydrocarbon/acrylic hybrid resin lithographic ink binders of the present invention are formed by heating a mixture of dicyclopentadiene, one or more hydrocarbon-based resins, one or more acrylic resins and, optionally, specified additional chemical compounds to temperatures of from about 140°C. to about 300°C. (preferably from about 180°C. to about 260°C.). The components are charged to a reactor which is then heated to a temperature within the desired range. The procedure generally is performed at atmospheric pressure; however, the reaction can be performed at an autogenous pressure. The reaction mixture is maintained at a temperature within the desired range for a period sufficient to bind the dicyclopentadiene and acrylic polymers together and to achieve a hydrocarbon/acrylic hybrid binder resin having the desired properties. Typically a period of time of at least two hours is employed.

79. Unexpectedly, the method by which the hydrocarbon/acrylic hybrid binder resin is prepared impacts the properties of the resin. That is, a different binder resin is obtained when the method of preparation is changed. Compared to the resins made according to the procedure of the first method, the resins of the second method are lower in softening point and molecular weight.

80. Hydrocarbon monomers suitable for producing the binder resins must be capable of undergoing polymerization with dicyclopentadiene. The hydrocarbon monomer typically employed to make the hydrocarbon/acrylic resin is a technical grade dicyclopentadiene containing from about 75 to 85% dicyclopentadiene. Examples of such materials that are commercially available are DCPD 101 (a product of Lyondell Petrochemical) and DCP-80P (a product of Exxon). Other components in the dicyclopentadiene are inert hydrocarbons (such as toluene, xylenes and saturated hydrocarbons with from 4 to 6 carbons), and various codimers and cotrimers formed by the Diels-Alder condensation of butadiene, cyclopentadiene, methylcyclopentadiene, and acyclic pentadienes.

81. The above-noted hydrocarbon monomers may be employed in thermal polymerization reactions to produce hydrocarbon resins and modified hydrocarbon resins suitable for use in producing the binder resins.

82. Likewise, aromatic hydrocarbons having a vinyl group conjugated to the aromatic ring may be employed to produce hydrocarbon resins and modified hydrocarbon resins suitable for use in producing the binder resins. The vinyl aromatic compounds are incorporated into the growing dicyclopentadiene containing polymer by free radical addition to the vinyl group. Examples of such aromatic monomers are styrene, vinyl toluene, α-methyl styrene, β-methyl styrene, indene and methyl indene. Typically, hydrocarbon mixtures that contain from 50 to 100% of such compounds are used. Other components found in these mixtures are usually inert aromatic compounds, e.g., toluene, xylenes, alkylbenzenes and naphthalene. A commercially available example of such a mixture is LRO-90® (a product of Lyondell Petrochemical). A typical analysis of this materials is: xylene (1-5%), styrene (1-10%), α-methylstyrene (1-3%), β-methylstyrene (1-5%), methylindene (5-15%), trimethylbenzenes (1-20%), vinyltoluene (1-30%), indene (1-15%) and naphthalene (1-5%).

83. When incorporating vinyl aromatic monomers to produce hydrocarbon resins or modified hydrocarbon resins, the procedure for preparing the resin is the same. The vinyl aromatic component is added along with the dicyclopentadiene and other hydrocarbon monomer. The aromatic component is added to the reaction mixture in an amount less than the dicyclopentadiene used. Generally, the aromatic component is employed in an amount no greater than 30% by weight of the total reaction mixture. Preferably, the vinyl aromatic component is used from about 5 to 20% of the total reagent charge.

84. For both synthetic methods for producing the binder resins, the amount of dicyclopentadiene monomer used in the preparation of the hydrocarbon/acrylic resin must be sufficient so as to provide at least one or more sites for the acrylic polymer to attach. Likewise, the acrylic polymer used in each method must have a sufficient number of acid sites so that at least one cycloaddition reaction with a dicyclopentadiene polymer can occur.

85. Although the mechanism of the reaction is not completely understood, it appears that an important aspect of the acrylic polymer is that the polymer possess: a) one or more carboxylic acid and/or carboxylic acid-precursor groups (i.e., be carboxylic acid functionalized), or b) that the polymer be both carboxylic acid functionalized and hydroxyl functionalized (i.e., also possess one or more hydroxyl and/or hydroxyl-precursor groups). These chemical characteristics permit the acrylic polymer to react in a cycloaddition reaction with the norbornyl-type double bonds in the dicyclopentadiene resin. In this way the acrylic polymer is chemically bound (grafted) to the hydrocarbon polymer, thereby yielding a hydrocarbon/acrylic graft copolymer.

86. The mechanism of grafting employed in the present invention is the cycloaddition of a carboxyl group on a preformed acrylic polymer across a double bond (e.g., norbornenyl double bonds) of the hydrocarbon resin. The attachment of the acrylic resin occurs through an ester linkage in the cycloaddition graft, thereby allowing the acrylic chains to be attached to the hydrocarbon somewhere at mid-chain of the acrylic resin. The employment of this cycloaddition mechanism affords the user a great deal of flexibility in designing desired graft polymer structures.

87. Polymers that contain more than one acid group or hydroxyl groups may be used and therefore are capable of reacting with more than one norbornyl-type double bond and acting as cross-linking agents between hydrocarbon polymer molecules. Furthermore, because the number of acid groups or hydroxyl groups on the acrylic polymer can be varied by changing the monomer composition, the crosslinking ability of the polymer can exceed that of modified rosin resins such as fumaric acid-adducted phenolic rosin resins, modified fatty acids such as maleic-anhydride-adducted linoleic acid, polyols such as pentaerythritol and sorbitol, polyamines such as 2-methylpentamethylene and hexamethylenediamine, polyaziridines such as IONAC® PFAZ-322 (supplied by Sybron Chemicals Inc.)] DYTEK® A (supplied by from DuPont Company) and IONAC® PFAZ-322 (supplied by from Sybron Chemicals Inc.), and alkanolamines such as diethanol amine. The use of acrylic polymers with multiple acid groups or hydroxyl groups allows the preparation of hydrocarbon/acrylic resins with blends of viscosity, solubility and softening point properties that cannot be obtained by using resins with one or several acid groups or hydroxyl groups. For example, the use of multiple acid group-containing polymers or multiple hydroxyl group-containing polymers allows the synthesis of hydrocarbon/acrylic resins of molecular weight, viscosity, softening point, and efflux cup dilution properties higher than achievable using materials such as rosin and fatty acid and their derivatives.

88. Alcohols which are suitable for use in producing the hydrocarbon/acrylic lithographic ink binder compositions are members selected from the group consisting of alcohols capable of undergoing an insertion reaction across a norbornyl site, alcohols capable of undergoing an esterification reaction with an acid group, alcohols capable of undergoing an esterification reaction with an acid equivalent functional group, and combinations thereof. Alkyl amines which are suitable for use in producing the hydrocarbon/acrylic lithographic ink binder compositions are members selected from the group consisting of alkyl amines capable of undergoing an insertion reaction across a norbornyl site, alkyl amines capable of undergoing an esterification reaction with an acid group, alkyl amines capable of undergoing an esterification reaction with an acid equivalent functional group, and combinations thereof. Where desired, the molecular weight of the hydrocarbon/acrylic resin can be increased by treating the hydrocarbon/acrylic resin with a compound containing one or more functionalities from the group consisting of polyols, polyamines, polyaziridines, alkanolamines, polysulfides, and alkanolsulfides. Examples of polyols suitable for use in the present methods include pentaerythritol, glycerin, ethylene glycol, sorbitol, and the like. Examples of suitable polyamines include 2-methylpentamethylenediamine, bis(hexamethylene) triamine, 1,3-pentanediamine, and the like. Examples of suitable polyaziridines include IONAC® PFAZ-322 (supplied by Sybron Chemicals Inc.) and similar compounds. Examples of suitable polysulfides include glycerol dimercaptoacetate, pentaerythritol tetra(3-mercaptopropionate), trimethylolpropane trithioglycolate, polyethylene glycol dimercaptoacetate, and the like. Examples of suitable alkanolsulfides include glycerol monothioglycolate, monoethanolamine thioglycolate, 1-thioglycerol, and the like.

89. Specific examples of preferred carboxylic acid-functionalized acrylic polymers usable herein include a copolymer of styrene or a styrene derivative with acrylic acid or methacrylic acid. Styrene monomers usable herein include styrene, and further, styrene derivatives such as methylstyrene, dimethylstyrene, trimethylstyrene, α-chlorostyrene, α-methylstyrene, and the like. The copolymers may contain other monomers. Examples of other monomers include -unsaturated monomers including vinyl halides, vinyl esters, mono vinylidene aromatics, α,β-unsaturated carboxylic acids and esters thereof, α,β-unsaturated dicarboxylic anhydrides, and mixtures thereof, and other monomers copolymerizable with styrene and (meth)acrylic acid. Polymerization methods are not particularly limited, and polymers having various monomer ratios are commercially available and may be used in the present invention.

90. Commercially available carboxylic acid-functionalized acrylic polymers include JONREZ® H-2700, H-2701, H-2702, and H-2704 (supplied by the Westvaco Corp.), JONCRYL® 678, 682, and 690 (supplied by S. C. Johnson, Inc.), MOREZ® 101 and 300 (supplied by Morton Int., Inc.), and VANCRYL® 65 and 68 (supplied by Air Products and Chemicals, Inc.). Commercially available hydroxyl-functionalized acrylic polymers include JONREZ® H-2703 (supplied by the Westvaco Corp.) and JONCRYL® 587 (supplied by S. C. Johnson, Inc.).

91. In a further embodiment of the invention, the hydrocarbon/acrylic resin may be reacted with α,β-unsaturated carboxylic acids, α,β-unsaturated carboxylic diacids, α,β-unsaturated carboxylic anhydrides, and the like. Examples of such carboxylic compounds which are suitable for use in producing the hydrocarbon/acrylic lithographic ink binder compositions of the present invention include those which are capable of undergoing an insertion reaction across a norbornyl site and/or an esterification reaction with an acid group or an acid equivalent functional group. Other carboxylic compounds which are suitable for use include those which are capable of Diels-Alder addition or ene reaction. Specific examples of such compounds include maleic anhydride, fumaric acid, itaconic acid, itaconic anhydride, crotonic acid, acrylic acid, methacrylic acid, and the like. These compounds react with the resin by a Diels-Alder addition or ene reaction, thus incorporating without loss of their carboxylic acid or anhydride functions. The reaction can be performed in the temperature range of 180-240° C., with the a range of 190-210° C. preferred. In general, from about 2 wt. % to about 15 wt. % of the α,β-unsaturated carboxylic acids, diacids or anhydrides can be added to the reaction mixture, but it is preferred that from about 4 wt. % to about 8 wt. % be used.

92. In a further embodiment of the invention, an α,β-unsaturated carboxylic acid, α,β-unsaturated carboxylic diacid, or α,β-unsaturated carboxylic anhydride can be incorporated into the hydrocarbon/acrylic resin during the polymerization reaction, thus incorporating without loss of their carboxylic acid or anhydride functions. Examples of such compounds are given in the previous paragraph. In general, from about 2 wt. % to about 40 wt. % of the α,β-unsaturated carboxylic acids, α,β-unsaturated carboxylic diacids, or α,β-unsaturated carboxylic anhydrides can be added to the reaction mixture, but it is preferred that from about 4 wt. % to about 15 wt. % be used.

93. In a further embodiment of the invention, the hydrocarbon/acrylic resin may be reacted with fatty acids, fatty acid compounds, rosin acids, and/or rosin resins. Examples of such compounds which are suitable for use in producing the hydrocarbon/acrylic lithographic ink binder compositions of the present invention include those which are capable of undergoing an insertion reaction across a norbornyl site and/or an esterification reaction with an acid group or an acid equivalent functional group.

94. Fatty acids which are suitable for use in the present invention include, but are not limited to, the following: unsaturated fatty acids, saturated fatty acids, dimerized fatty acids, modified fatty acids, and combinations thereof. Suitable fatty acid compounds include the Diels-Alder cyclo-adducts and the ene-addition reaction products of unsaturated and polyunsaturated fatty acids with acrylic acid, acrylic acid derivatives, fumaric acid, and/or maleic anhydride.

95. In a further embodiment of the invention, rosin and rosin-based resins can be incorporated into the hydrocarbon/acrylic resin either during or after the polymerization reaction. Rosins suitable for this invention include tall oil rosin, gum rosin and wood rosin. Synthetic sources of these rosin acids may also be used. The modification of rosin with components such as phenols, α,β-unsaturated carboxylic acid, and polyols to produce rosin-based resins is a well established method for producing rosin-based resins. Examples of such suitable rosin-based resins are the JONREZ® RP-300, SM-700, IM-800, and HC-900 resin series (supplied by the Westvaco Corp.).

96. In a further embodiment of the invention, mononuclear phenols, polynuclear phenols, or phenol-based resins (i.e., novolacs or resoles) can be incorporated into the hydrocarbon/acrylic resin either during or after the polymerization reaction. Examples of such phenolic compounds which are suitable for use in producing the hydrocarbon/acrylic lithographic ink binder compositions of the present invention include those which are capable of undergoing an insertion reaction across a norbornyl site and/or an esterification reaction with an acid group or an acid equivalent functional group. These phenolic compounds can also be reacted with suitable aldehydes and/or aldehyde acetals either prior to or following the insertion reaction or esterification reaction. Among the phenolic compounds that can be used to modify the resin are phenol, bisphenol-A, para-tert-butylphenol, para-octylphenol, para-nonylphenol, para-dodecylphenol, para-phenylphenol, novolac resins such as HRJ-1166, HRJ-1367, SP-134, SP-560, SP-1068, SP-1077, and SRF-1524 (all supplied by Schenectady International, Inc.), resole resins, and mixtures thereof. Aldehydes which are suitable for use in the present invention include, but are not limited to, the following: paraformaldehyde, formaldehyde, and combinations thereof.

97. Resins suitable for use in this invention are characterized by acid number (ASTM D465-92) and softening point (ASTM E28-92). The units for acid number as reported here are mg KOH/gram of resin. Suitable acid numbers are from about 5 to about 50 for lithographic inks, preferably from about 10 to about 25. Suitable softening points are from about 100° C. to about 210° C. for lithographic inks, preferably from about 150° C. to about 180°C.

98. The resins of this invention suitable for use in lithographic inks are further characterized by viscosity and tolerance to ink solvents. Viscosity is determined by timing the rate of rise (in seconds) of a bubble through a solution of the resin in a glass tube from one line of the tube to another line. The resins of this invention suitable for use in lithographic inks are further characterized by line-to-line viscosities of 60 seconds or more at 25° C. and at 60% resin solids in a commercially available high-boiling hydrocarbon solvent known as MAGIESOL® 47 (a hydrocarbon solvent supplied by Magie Brothers Oil Co.). The above described properties of the resins of this invention can be controlled by the composition of the resin and the processing conditions.

99. The colorant generally is a pigment; specifically, a common pigment used in lithographic printing inks well-known to those of ordinary skill in the printing art. In addition to pigments, dyes may also be used. The amount of colorant present in the instant invention is generally from about 1% to about 20%; preferably from about 2% to about 10%.

100. Novel hydrocarbon/acrylic hybrid binder resin compositions which are the subject of the present invention are readily dissolved in high-boiling hydrocarbon solvents to give varnishes useful in lithographic inks and particularly in pigment dispersing operations known as flushing. The amount of solvent contained in the ink composition is adjusted to obtain the desired viscosity, rheological, evaporation, and print qualities. Use of varnishes based upon these resin binder compounds in dispersion processes results in lithographic ink formulations having increased gloss, transparency, and color strength, as well as reduced bronzing in both pigment concentrates and finished lithographic inks.

101. The following examples are provided to further illustrate the present invention and are not to be construed as limiting the invention in any manner. All parts are by weight unless otherwise stated.

### EXAMPLE 1

102. Into a one-liter autoclave reactor were charged 1401 parts of DCPD 101® (a dicyclopentadiene supplied by from Lyondell Petrochemical), 601 parts LRO-90® (a hydrocarbon mixture containing vinyl aromatic compounds supplied by Lyondell Petrochemical), 120 parts of NEODENE® 16 (a 1-hexadecene supplied by Shell Chemical Co.), and 401 parts JONREZ® H-2704 (an acrylic polymer having an acid number of 90 supplied by the Westvaco Corp.). The charged autoclave was purged with nitrogen and sealed. The reaction mixture was heated to 274° C. over a two hour period and was maintained at 260°C. for 2.5 hours. The reactor was then vented carefully, and the molten resin was poured into an aluminum pan and was allowed to cool.

103. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 220° C. At 220° C., the nitrogen inlet tube was immersed in the liquid resin and the nitrogen flow was adjusted to a rate of approximately 400 ml/min. The resin was sparged for two hours and then discharged into an aluminum pan.

104. The resulting hydrocarbon/acrylic binder resin had an acid number of 1, a glass transition temperature of 38° C., weight average molecular weight of 5860 daltons and a Ring and Ball softening point of 78° C.

### EXAMPLE 2

105. A gelled varnish was prepared with the resin described in Example 1 according to the following procedure. Into a one-liter, four-neck, round-bottom flask equipped with an electric heating mantle, overhead stirrer, thermocouple, nitrogen inlet tube, and Barret trap attached to a water-cooled condenser was added 34 parts JONREZ® RP-346 (a phenolic rosin resin commercially available from the Westvaco Corp.), 13 parts of the acrylic/hydrocarbon binder resin described in Example 1, 9 parts alkaline refined linseed oil, and 43 parts MAGIE® M-4700 (a hydrocarbon solvent supplied by Magie Brothers Oil Co.). The contents were heated to a temperature of 155° C. and 1 part oxyaluminum octoate was added. The temperature was increased to 165° C. and maintained for 45 minutes. The dilutions was 37%.

106. A lithographic ink was prepared with the varnish by mixing 50 parts of the varnish, 40 parts of a lithol rubine colorant supplied by Sun Chemicals, and 10 parts of MAGIE® M-4700 (a hydrocarbon solvent supplied by Magie Brothers Oil Co.). Laray viscosity and yield value were measured at 25°C. using a Duke D-2102 viscometer. The ink had an apparent viscosity of 211 poise (at 2500 sec⁻¹), a yield value of 6080 dynes/cm² (at 2.5 sec⁻¹), and a shortness ratio of 11.5. The resulting ink exhibited excellent color development and outstanding rub resistant properties.

### EXAMPLE 3

107. Into a one-liter autoclave reactor were charged 350 parts of DCPD 101® (a dicyclopentadiene supplied by Lyondell Petrochemical), 150 parts LRO-90® (a hydrocarbon mixture containing vinyl aromatic compounds supplied by Lyondell Petrochemical), 100 parts SAAEHA (a polymer comprised of 60 wt. % styrene, 20 wt. % acrylic acid, and 20 wt. % 2-ethyl hexyl acrylate and having an acid number of 128), and 25 parts NEODENE® 16 (a 1-hexadecene supplied by Shell Chemical Co.). The charged autoclave was purged with nitrogen and sealed. The reaction mixture was heated to 265° C. over a 45 minute period and was maintained at 260°C. for five hours. The reactor was then vented carefully, and the molten resin was poured into an aluminum pan and was allowed to cool.

108. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260°C. At 260°C., the nitrogen inlet tube was immersed in the liquid resin and the nitrogen flow was adjusted to a rate of approximately 400 ml/min. The resin was sparged for 30 minutes and then discharged into an aluminum pan.

109. The resulting hydrocarbon/acrylic resin had an acid number of 4, a Ring and Ball softening point of 111° C., a viscosity at 25° C. of 9 line-to-line seconds (33 wt. % resin in alkaline refined linseed oil) and 20 line-to-line seconds (50 wt. % resin in MAGIESOL® 47 oil [a hydrocarbon solvent supplied by Magie Brothers Oil Co.]), 45% tolerance (titration of the resin/MAGIESOL® 47 oil solution with additional MAGIESOL® 47 oil until a cloud point is reached), and Gardner color of 11+ (33 wt. % resin in alkaline refined linseed oil).

### EXAMPLE 4

110. Into a one-liter autoclave reactor were charged 350 parts of DCPD 101® (a dicyclopentadiene supplied by Lyondell Petrochemical), 150 parts LRO-90® (a hydrocarbon mixture containing vinyl aromatic compounds supplied by Lyondell Petrochemical), and 100 parts of SAAEHA (a solution polymer comprised of 60 wt. % styrene, acrylic acid, and 2-ethyl hexyl acrylate and having an acid number of 128). The charged autoclave was purged with nitrogen and sealed. The reaction mixture was heated to 265°C. over a 90 minute period and was maintained at 260°C. for four hours. The reactor was then vented carefully, and the molten resin was poured into an aluminum pan and was allowed to cool.

111. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260°C. At 260°C., the nitrogen inlet tube was immersed in the liquid resin and the nitrogen flow was adjusted to a rate of approximately 400 ml/min. The resin was sparged for 30 minutes and then discharged into an aluminum pan.

112. The resulting hydrocarbon/acrylic resin had an acid number of 5, a Ring and Ball softening point of 121° C., a viscosity at 25°C. of 14 line-to-line seconds (33 wt. % resin in alkaline refined linseed oil), and Gardner color of 11+(33 wt. % resin in alkaline refined linseed oil). The resin was not soluble in MAGIESOL® 47 oil (a hydrocarbon solvent supplied by Magie Brothers Oil Co.).

### EXAMPLE 5

113. Into a one-liter autoclave reactor were charged 390 parts of DCPD 101® (a dicyclopentadiene supplied by Lyondell Petrochemical), 182 parts LRO-90® (a hydrocarbon mixture containing vinyl aromatic compounds supplied by Lyondell Petrochemical), 26 parts SAAEHA (a solution polymer comprised of 60 wt. % styrene, 20 wt. % acrylic acid, and 20 wt. % 2-ethyl hexyl acrylate and having an acid number of 128), 26 parts maleic anhydride, and 26 parts NEODENE® C-16 (a 1-hexadecene supplied by Shell Chemical Co.). The charged autoclave was purged with nitrogen and sealed. The reaction mixture was heated to 265° C. over a 30 minute period and was maintained at 260°C. for six hours. The reactor was then vented carefully, and the molten resin was poured into an aluminum pan and was allowed to cool.

114. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260°C. At 260°C., the nitrogen inlet tube was immersed in the liquid resin and the nitrogen flow was adjusted to a rate of approximately 400 ml/min. The resin was sparged for four hours and then discharged into an aluminum pan.

115. The resulting hydrocarbon/acrylic resin had an acid number of 24, a Ring and Ball softening point of 90° C., a viscosity at 25° C. of 5 line-to-line seconds (33 wt. % resin in alkaline refined linseed oil), a Gardner color of 11+(33 wt. % resin in alkaline refined linseed oil), and a efflux cup dilution (#2 Shell Cup, 25° C., 18 sec end point) of 22 mL.

### EXAMPLE 6

116. Into a one-liter autoclave reactor were charged 390 parts of DCPD 101® (a dicyclopentadiene supplied by Lyondell Petrochemical), 182 parts LRO-90® (a hydrocarbon mixture containing vinyl aromatic compounds supplied by Lyondell Petrochemical), 26 parts SAAEHA (a polymer comprised of 60 wt. % styrene, 20 wt. % acrylic acid, and 20 wt. % 2-ethyl hexyl acrylate and having an acid number of 128), 13 parts maleic anhydride, and 26 parts NEODENE® C-16 (1-hexadecene supplied by Shell Chemical Co.). The charged autoclave was purged with nitrogen and sealed. The reaction mixture was heated to 265° C. over a 30 minute period and was maintained at 260°C. for six hours. The reactor was then vented carefully, and the molten resin was poured into an aluminum pan and was allowed to cool.

117. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260°C. At 260°C., the nitrogen inlet tube was immersed in the liquid resin and the nitrogen flow was adjusted to a rate of approximately 400 ml/min. The resin was sparged for one hour and then discharged into an aluminum pan.

118. The resulting hydrocarbon/acrylic resin had an acid number of 14, a Ring and Ball softening point of 137° C., a viscosity at 25°C. of 8 line-to-line seconds (33 wt. % resin in Alkaline refined linseed oil) and 16 line-to-line seconds (50 wt. % resin in MAGIESOL® 47 oil [a hydrocarbon solvent supplied by Magie Brothers Oil Co.]), and 44% tolerance (titration of the resin/MAGIESOL® 47 oil solution with additional oil until a cloud point is reached).

### EXAMPLE 7

119. Into a one-liter autoclave reactor were charged 390 parts of DCPD 101® (a dicyclopentadiene supplied by Lyondell Petrochemical), 182 parts LRO-90® (a hydrocarbon mixture containing vinyl aromatic compounds supplied by Lyondell Petrochemical), 26 parts 7098-26 (a polymer comprised of 83.5 wt. % styrene, 6.5 wt. % acrylic acid, and 10.0 wt. % isodecyl methacrylate and having an acid number of 44), 13 parts maleic anhydride, and 26 parts NEODENE® C-16 (1-hexadecene supplied by Shell Chemical Co.). The charged autoclave was purged with nitrogen and sealed. The reaction mixture was heated to 265° C. over a one hour period and was maintained at 260°C. for 6.5 hours. The reactor was then vented carefully, and the molten resin was poured into an aluminum pan and was allowed to cool.

120. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260°C. At 260°C., the nitrogen inlet tube was immersed in the liquid resin and the nitrogen flow was adjusted to a rate of approximately 400 ml/min. The resin was sparged for four hours and then discharged into an aluminum pan.

121. The resulting hydrocarbon/acrylic resin had an acid number of 14, a Ring and Ball softening point of 141°C., a viscosity at 250°C. of 8 line-to-line seconds (33 wt. % resin in alkaline refined linseed oil), a Gardner color of 12+(33 wt. % resin in alkaline refined linseed oil), and a efflux cup dilution (#2 Shell Cup, 25° C., 18 sec end point) of 28 mL.

### EXAMPLE 8

122. Into a one-liter autoclave reactor were charged 1401 parts of DCPD 101® (a dicyclopentadiene supplied by Lyondell Petrochemical), 602 parts LRO-90® (a hydrocarbon mixture containing vinyl aromatic compounds supplied by Lyondell Petrochemical), 120 parts of NEODENE® 16 (a 1-hexadecene supplied by Shell), and 100 parts JONREZ® H-2701 (a styrene/acrylic polymer having an acid number of 206 supplied by the Westvaco Corp.). The charged autoclave was purged with nitrogen and sealed. The reaction mixture was heated to 260°C. over a 90 minute period and was maintained at 260°C. for five hours. The reactor was then vented carefully, and the molten resin was poured into an aluminum pan and was allowed to cool. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 220° C. At 220° C., the nitrogen inlet tube was immersed in the liquid resin and the nitrogen flow was adjusted to a rate of approximately 400 ml/min. The resin was sparged for two hours and then discharged into an aluminum pan.

123. The resulting hydrocarbon/acrylic resin had an acid number of 4, a glass transition temperature of 2° C., a weight average molecular weight of 5960 daltons, a Brookfield viscosity at 135° C. of 4780 cP, and a Ring and Ball softening point of 79° C.

### EXAMPLE 9

124. Into a one-liter autoclave reactor were charged 1708 parts of DCPD 101® (a dicyclopentadiene supplied by Lyondell Petrochemical), 752 parts LRO-90® (a hydrocarbon mixture containing vinyl aromatic compounds supplied by Lyondell Petrochemical), and 150 parts NEODENE® 16 (a 1-hexadecene supplied by Shell). The charged autoclave was purged with nitrogen and sealed. The reaction mixture was heated to 260°C. over a two hour period and was maintained at 260°C. for five hours. The reactor was then vented carefully, and the molten resin was poured into an aluminum pan and was allowed to cool.

125. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 220° C. At 220° C., the nitrogen inlet tube was immersed in the liquid resin and the nitrogen flow was adjusted to a rate of approximately 400 ml/min. The resin was sparged for two hours and then discharged into an aluminum pan.

126. The resulting hydrocarbon/acrylic resin had a glass transition temperature of 3° C., a weight average molecular weight of 1290 daltons, a Brookfield viscosity at 135° C. of 455 cP, and a Ring and Ball softening point of 54° C.

### EXAMPLE 10

127. To a one-liter, four-neck, round-bottom flask equipped with an electric heating mantle, overhead stirrer, thermocouple, nitrogen inlet tube, and Barret trap attached to a water-cooled condenser were added 400 parts of the resin prepared in Example 18 and 126 parts JONREZ® H-2701 (a styrene/acrylic acid polymer having an acid number of 206 supplied by the Westvaco Corp.). The contents of the flask were heated to a temperature of 220° C. After five hours at 220° C., the resulting hydrocarbon/acrylic resin was collected in an aluminum pan. The resin had an acid number of 32, a weight average molecular weight of 8700 daltons, and a softening point of 146°C.

### EXAMPLE 11

128. To a one-liter, four-neck, round-bottom flask equipped with an electric heating mantle, overhead stirrer, thermocouple, nitrogen inlet tube, and Barret trap attached to a water-cooled condenser were added 1000 parts of the resin prepared in Example 18 and 190 parts JONREZ® H-2703 (a styrene/acrylic acid polymer having an acid number of 206 supplied by the Westvaco Corp.). The contents of the flask were heated to a temperature of 260°C. After five hours at 260°C., the resulting hydrocarbon/acrylic resin was collected in an aluminum pan. The resin had a weight average molecular weight of 2170 daltons, a glass transition temperature of 31° C., and a softening point of 101° C.

### EXAMPLE 12

129. To a one-liter, four-neck, round-bottom flask equipped with an electric heating mantle, overhead stirrer, thermocouple, nitrogen inlet tube, and Barret trap attached to a water-cooled condenser were added 350 parts of the resin described in Example 17 and 40 parts maleic anhydride. The contents of the flask were heated to a temperature of 190° C. After five hours at 190° C., the resulting hydrocarbon/acrylic resin was collected in an aluminum pan. The resin had an acid number of 60, a weight average molecular weight of 7970 daltons, and a softening point of 121° C.

### EXAMPLE 13

130. Into a one-liter autoclave reactor were charged 1399 parts of DCPD 101® (a dicyclopentadiene supplied by Lyondell Petrochemical), 603 parts LRO-90® (a hydrocarbon mixture containing vinyl aromatic compounds supplied by Lyondell Petrochemical), 120 parts of NEODENE® 16 (a 1-hexadecene supplied by Shell), and 402 parts JONREZ® H-2703 (a styrene/acrylic polymer having a hydroxyl value of 90 supplied by the Westvaco Corp.). The charged autoclave was purged with nitrogen and sealed. The reaction mixture was heated to 260°C. over a 90 minute period and was maintained at 260°C. for five hours. The reactor was then vented carefully, and the molten resin was poured into an aluminum pan and was allowed to cool.

131. Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 220° C. At 220° C., the nitrogen inlet tube was immersed in the liquid resin and the nitrogen flow was adjusted to a rate of approximately 400 ml/min. The resin was sparged for two hours and then discharged into an aluminum pan.

132. The resulting hydrocarbon/acrylic resin had a weight average molecular weight of 1760 daltons and a Ring and Ball softening point of 81° C.

133. While the invention has been described and illustrated herein by references to various specific materials, procedures, and examples, it is understood that the invention is not restricted to the particular materials, combination of materials, and procedures selected for that purpose. Many modifications and variations of the present invention will be apparent to one of ordinary skill in the art in light of the above teachings. It is therefore understood that the scope of the invention is not to be limited by the foregoing description, but rather is to be defined by the claims appended hereto.

What is claimed is:

1. A lithographic ink binder composition for use in lithographic ink formulations comprising the hydrocarbon/acrylic graft copolymer reaction product produced by reacting:
a) about 2% to about 63% by total weight of the reactants of dicyclopentadiene;
b) about 2% to about 63% by total weight of the reactants of a member selected from the group consisting of hydrocarbon monomers which undergo polymerization with dicyclopentadiene and combinations thereof;
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and
d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof,
at a temperature of from about 160° C. to about 300°C. for a time sufficient to produce the lithographic ink binder composition.

2. The lithographic ink binder composition of claim 1 which further comprises the reaction product produced by reacting:
a) about 10% to about 40% by total weight of the reactants of dicyclopentadiene;
b) about 10% to about 40% by total weight of the reactants of a member selected from the group consisting of hydrocarbon monomers which undergo polymerization with dicyclopentadiene and combinations thereof;
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and
d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 220° C. to about 280°C. for a time sufficient to produce the lithographic ink binder composition.

3. The lithographic ink binder composition of claim 1 wherein said alcohol is a member selected from the group consisting of alcohols which undergo an insertion reaction across a norbornyl site, alcohols which undergo an esterification reaction with an acid group, alcohols which undergo an esterification reaction with an acid equivalent functional group, and combinations thereof.

4. The lithographic ink binder composition of claim 1 wherein said alkyl amine is a member selected from the group consisting of alkyl amines which undergo an insertion reaction across a norbornyl site, alkyl amines which undergo an esterification reaction with an acid group, alkyl amines which undergo an esterification reaction with an acid equivalent functional group, and combinations thereof.

5. The lithographic ink binder composition of claim 1 wherein said α,β-unsaturated carboxylic acid is a member selected from the group consisting of α,β-unsaturated carboxylic acids which undergo an insertion reaction across a norbornyl site, α,β-unsaturated carboxylic acids which undergo an esterification reaction with an acid group, α,β-unsaturated carboxylic acids which undergo an esterification reaction with an acid equivalent functional group, α,β-unsaturated carboxylic acids which undergo a Diels-Alder addition reaction, α,β-unsaturated carboxylic acids which undergo an ene-reaction, and combinations thereof.

6. The lithographic ink binder composition of claim 1 wherein said α,β-unsaturated carboxylic diacid is a member selected from the group consisting of α,β-unsaturated carboxylic diacids which undergo an insertion reaction across a norbornyl site, α,β-unsaturated carboxylic diacids which undergo an esterification reaction with an acid group, α,β-unsaturated diacids which undergo an esterification reaction with an acid equivalent functional group, α,β-unsaturated carboxylic diacids which undergo a Diels-Alder addition reaction, α,β-unsaturated carboxylic diacids which undergo an ene-reaction, and combinations thereof.

7. The lithographic ink binder composition of claim 1 wherein said α,β-unsaturated carboxylic anhydride is a member selected from the group consisting of α,β-unsaturated carboxylic anhydrides which undergo an insertion reaction across a norbornyl site, α,β-unsaturated carboxylic anhydrides which undergo an esterification reaction with an acid group, α,β-unsaturated anhydrides which undergo an esterification reaction with an acid equivalent functional group, α,β-unsaturated carboxylic anhydrides which undergo a Diels-Alder addition reaction, α,β-unsaturated carboxylic anhydrides which undergo an ene-reaction, and combinations thereof.

8. The lithographic ink binder composition of claim 1 wherein said fatty acid is a member selected from the group consisting of fatty acids which undergo an insertion reaction across a norbornyl site, fatty acids which undergo an esterification reaction with an acid group, fatty acids which undergo an esterification reaction with an acid equivalent functional group, fatty acids which undergo a Diels-Alder addition reaction, fatty acids which undergo an ene-reaction, and combinations thereof.

9. The lithographic ink binder composition of claim 1 wherein said fatty acid compound is a member selected from the group consisting of fatty acid compounds which undergo an insertion reaction across a norbornyl site, fatty acid compounds which undergo an esterification reaction with an acid group, fatty acid compounds which undergo an esterification reaction with an acid equivalent functional group, fatty acid compounds which undergo a Diels-Alder addition reaction, fatty acid compounds which undergo an ene-reaction, and combinations thereof.

10. The lithographic ink binder composition of claim 1 wherein said rosin acid is a member selected from the group consisting of tall oil rosin, gum rosin, wood rosin, and combinations thereof.

11. The lithographic ink binder composition of claim 1 wherein said mononuclear phenol is a member selected from the group consisting of mononuclear phenols which undergo an insertion reaction across a norbornyl site, mononuclear phenols which undergo an esterification reaction with an acid group, mononuclear phenols which undergo an esterification reaction with an acid equivalent functional group, and combinations thereof.

12. The lithographic ink binder composition of claim 1 wherein said polynuclear phenol is a member selected from the group consisting of polynuclear phenols which undergo an insertion reaction across a norbornyl site, polynuclear phenols which undergo an esterification reaction with an acid group, polynuclear phenols which undergo an esterification reaction with an acid equivalent functional group, and combinations thereof.

13. The lithographic ink binder composition of claim 1 wherein said resole is a member selected from the group consisting of resoles which undergo an insertion reaction across a norbornyl site, resoles which undergo an esterification reaction with an acid group, resoles which undergo an esterification reaction with an acid equivalent functional group, and combinations thereof.

14. The lithographic ink binder composition of claim 1 wherein said novolac is a member selected from the group consisting of novolacs which undergo an insertion reaction across a norbornyl site, novolacs which undergo an esterification reaction with an acid group, novolacs which undergo an esterification reaction with an acid equivalent functional group, and combinations thereof.

15. The lithographic ink binder composition of claim 1 wherein said aldehyde is a member selected from the group consisting of paraformaldehyde, formaldehyde, and combinations thereof.

16. A lithographic ink composition comprising solvent, colorant, and the lithographic ink binder composition of claim 1.

17. A lithographic ink binder composition for use in lithographic ink formulations comprising the hydrocarbon/acrylic graft copolymer reaction product produced by:
1) reacting
a) about 2% to about 63% by total weight of the reactants of dicyclopentadiene;
b) about 2% to about 63% by total weight of the reactants of a member selected from the group consisting of hydrocarbon monomers which undergo polymerization with dicyclopentadiene and combinations thereof; and
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b);
at a temperature of from about 160° C. to about 300°C. for a time sufficient to produce a resin composition; and
2) further reacting:
a) about 35% to about 98% by total weight of the reactants of said resin composition, and
b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 160° C. to about 300°C. for a time sufficient to produce the lithographic ink binder composition.

18. The lithographic ink binder composition of claim 17 which further comprises:
1) reacting
a) about 10% to about 40% by total weight of the reactants of dicyclopentadiene;
b) about 10% to about 40% by total weight of the reactants of a member selected from the group consisting of hydrocarbon monomers which undergo polymerization with dicyclopentadiene and combinations thereof; and
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b);
at a temperature of from about 220° C. to about 280°C. for a time sufficient to produce a resin composition, and
2) further reacting
b) about 50% to about 80% by total weight of the reactants of said resin composition, and
b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 220° C. to about 280°C. for a time sufficient to produce the lithographic ink binder composition.

19. A lithographic ink composition comprising solvent, colorant, and the lithographic ink binder composition of claim 17.

20. A lithographic ink binder composition for use in lithographic ink formulations comprising the hydrocarbon/acrylic graft copolymer reaction product produced by reacting:
a) about 2% to about 63% by total weight of the reactants of dicyclopentadiene;
b) about 2% to about 63% by total weight of the reactants of a member selected from the group consisting of hydrocarbon resins, modified hydrocarbon resins, and combinations thereof,
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b); and
d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 140°C. to about 300°C. for a time sufficient to produce the lithographic ink binder composition.

21. The lithographic ink binder composition of claim 20 which further comprises reacting:
a) about 10% to about 40% by total weight of the reactants of dicyclopentadiene;
b) about 10% to about 40% by total weight of the reactants of a member selected from the group consisting of hydrocarbon resins, modified hydrocarbon resins, and combinations thereof,
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b); and
d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 180° C. to about 260° C. for a time sufficient to produce the lithographic ink binder composition.

22. A lithographic ink composition comprising solvent, colorant, and the lithographic ink binder composition of claim 20.

23. A lithographic ink binder composition for use in lithographic ink formulations comprising the hydrocarbon/acrylic graft copolymer reaction product produced by:
1) reacting
a) about 2% to about 63% by total weight of the reactants of dicyclopentadiene;
b) about 2% to about 63% by total weight of the reactants of a member selected from the group consisting of hydrocarbon resins, modified hydrocarbon resins, and combinations thereof; and
c) about 33% to about 96% by total weight of the reactants of a member selected from the group consisting of acrylic polymers that are carboxylic acid functionalized, to acrylic polymers that are carboxylic acid functionalized and hydroxyl functionalized, and combinations thereof, and wherein said reactants are which undergo cycloaddition reaction with components a) and b);
at a temperature of from about 140°C. to about 300°C. for a time sufficient to produce a resin composition; and
2) further reacting:
a) about 35% to about 98% by total weight of the reactants of said resin composition, and
b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 140°C. to about 300°C. for a time sufficient to produce the lithographic ink binder composition.

24. The lithographic ink binder composition of claim 23 which further comprises:
1) reacting
a) about 10% to about 40% by total weight of the reactants of dicyclopentadiene;
b) about 10% to about 40% by total weight of the reactants of a member selected from the group consisting of hydrocarbon resins, modified hydrocarbon resins, and combinations thereof; and
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are which undergo cycloaddition reaction with components a) and b);
at a temperature of from about 180°C. to about 260°C. for a time sufficient to produce a resin composition, and
2) further reacting
a) about 50% to about 80% by total weight of the reactants of said resin composition, and
b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 180°C. to about 260°C. for a time sufficient to produce the hydrocarbon/acrylic resin composition.

25. A lithographic ink composition comprising solvent, colorant, and the lithographic ink binder composition of claim 23.
